(19) United States
(12) Patent Application Publication
(10) Pub. No.: US 2026/0063855 A1
(43) Pub. Date: Mar. 5, 2026

(54) OPTICAL RECEPTACLE AND OPTICAL MODULE

(71) Applicant: Enplas Corporation, Saitama (JP)

(72) Inventors: Yuto KUJIRAI, Saitama (JP); Ayano HINATA, Saitama (JP)

(73) Assignee: Enplas Corporation, Saitama (JP)

(21) Appl. No.: 19/312,328

(22) Filed: Aug. 28, 2025

(30) Foreign Application Priority Data
Aug. 30, 2024 (JP) 2024-149354

(51) Int. Cl. G02B 6/42

(52) U.S. Cl. CPC G02B 6/4214

(57) ABSTRACT

An optical receptacle of the present invention includes a first part disposed on one side in a first direction, a second part disposed on the other side in the first direction, a pair of side connection portions that connect the first part with the second part, a rib that is disposed between the pair of side connection portions and connects the first part with the second part, and a thin-wall portion that is disposed in a space surrounded by the first part, the second part, and the pair of side connection portions. In the optical receptacle, a first weld line is designed to be formed on the thin-wall portion.

### RELATED APPLICATION(S)

This application claims the benefit of priority of Japanese Patent Application No. 2024-149354, filed on Aug. 30, 2024, the contents of the above application are all incorporated by reference as if fully set forth herein in their entirety.

### TECHNICAL FIELD

The present invention relates to an optical receptacle and an optical module.

### Background Art

In the related art, an optical module for optically connecting an optical fiber with a photoelectric conversion element disposed on a substrate is known. For example, PTL 1 discloses an optical component module for connecting an optical fiber with an electronic component. PTL 1 states that there is a demand for reducing the thickness of such an optical component module.

### CITATION LIST

### Patent Literature

PTL 1

Japanese Patent Application Laid-Open No. 2004-87150

### SUMMARY OF INVENTION

### Technical Problem

FIG. 1A is a cross-sectional view illustrating an example of optical module 20 for optically connecting the above-described optical transmission member (for example, an optical fiber) and photoelectric conversion element 10, which is a type of an electronic component, disposed on substrate 10a. Optical module 20 may be used as optical module 20 for light transmission or optical module 20 for light reception.

When optical module 20 is used as optical module 20 for light transmission, as illustrated in FIG. 1A, light emitted from photoelectric conversion element 10 disposed on substrate 10a enters optical receptacle 30 through first optical surface 31, is reflected by reflecting surface 32, and is emitted from optical receptacle 30 through second optical surface 33 to reach an optical transmission member (not illustrated). In this manner, in optical module 20, a traveling direction of the light is controlled by optical receptacle 30, and photoelectric conversion element 10 and the optical transmission member are optically connected to each other.

Here, in the example illustrated in FIG. 1A, when a surface of optical receptacle 30 in contact with substrate 10a is bottom surface 30a, first optical surface 31 is disposed on an inner surface of a recess portion provided to be recessed with respect to bottom surface 30a, and reflecting surface 32 is an inclined inner surface of a recess portion provided to be recessed from a top surface opposite to the bottom surface. The configuration (first optical surface 31 and reflecting surface 32) of optical receptacle 30 for controlling the light as described above can be formed by forming the recess portions in optical receptacle 30.

When a plurality of recess portions are provided in optical receptacle 30 as described above, thin-wall portion 34 may be formed in optical receptacle 30 at a position between two recess portions (see FIG. 1B, namely a partially enlarged view of FIG. 1A). For producing optical receptacle 30 by injection molding, a portion of a molding die corresponding to thin-wall portion 34 is a portion through which the material has difficulty passing. Therefore, optical receptacle 30 including thin-wall portion 34 tends to have many molding defects. When the thickness of optical receptacle 30 is reduced as described in PTL 1, thin-wall portion 34 becomes thinner accordingly, so that molding defects become more noticeable and weld lines tend to be easily formed in positions that affect the performance of optical receptacle 30.

An object of the present invention is to provide an optical receptacle that can suppress molding defects during the injection molding of the optical receptacle including a thin-wall portion. Another object of the present invention is to provide an optical module including the optical receptacle.

### Solution to Problem

[1] An optical receptacle for optically connecting a photoelectric conversion element with an end surface of an optical transmission member when the optical receptacle is disposed between the photoelectric conversion element and the optical transmission member, the optical receptacle including: a first part that is disposed on one side in a first direction and has an optical function for optically connecting the photoelectric conversion element with the end surface of the optical transmission member; a second part that is disposed on another side in the first direction and includes a gate mark or a gate remnant; a pair of side connection portions that connect the first part with the second part; a rib that is disposed between the pair of side connection portions and connects the first part with the second part; and a thin-wall portion that is disposed in a space surrounded by the first part, the second part, and the pair of side connection portions and has a thickness smaller than those of the pair of side connection portions and the rib, the space being a space in which the rib is not located, in which
   the first part, the second part, the pair of side connection portions, the rib, and the thin-wall portion are integrally molded; and respective cross-sectional areas of the pair of side connection portions, the rib, and the thin-wall portion in a cross section in a direction orthogonal to the first direction are designed in such a way that a first weld line is formed on the thin-wall portion.
[2] The optical receptacle according to [1], in which the thickness of thin-wall portion is 0.09 mm or more.
[3] The optical receptacle according to [1] or [2], in which the first part includes a second weld line at a position at which the second weld line does not overlap an optical path of the optical function.
[4] The optical receptacle according to any one of [1] to [3], in which the gate mark or the gate remnant is disposed on an extension line of the rib.
[5] The optical receptacle according to any one of [1] to [4], in which the first part includes: a first optical surface for allowing light emitted from the photoelectric conversion element to be incident on the first optical surface or for emitting, toward the photoelectric conversion element, light emitted from the end surface of the optical transmission member and passing through an inside of the first part; a second optical surface for emitting, toward the end surface of the optical transmission member, the light incident on the first optical surface or for allowing the light emitted from the end surface of the optical transmission member to be incident on the second optical surface; and a reflecting surface for reflecting the light from the first optical surface toward the second optical surface or for reflecting the light from the second optical surface toward the first optical surface.
[6] The optical receptacle according to [5], in which in a direction along an optical path between the first optical surface and the reflecting surface, a distance from an intersection between an optical axis of the second optical surface and the second optical surface to a bottom surface of the optical receptacle is 1.1 mm or less.
[7] An optical module including a photoelectric conversion element and the optical receptacle according to any one of [1] to [6].

### Advantageous Effects of Invention

The present invention is capable of providing the optical receptacle that can suppress the molding defects during the injection molding of an optical receptacle including the thin-wall portion. In addition, the present invention is capable of providing the optical module including the optical receptacle.

### BRIEF DESCRIPTION OF DRAWINGS

FIGS. 1A and 1B are views for describing an optical module;

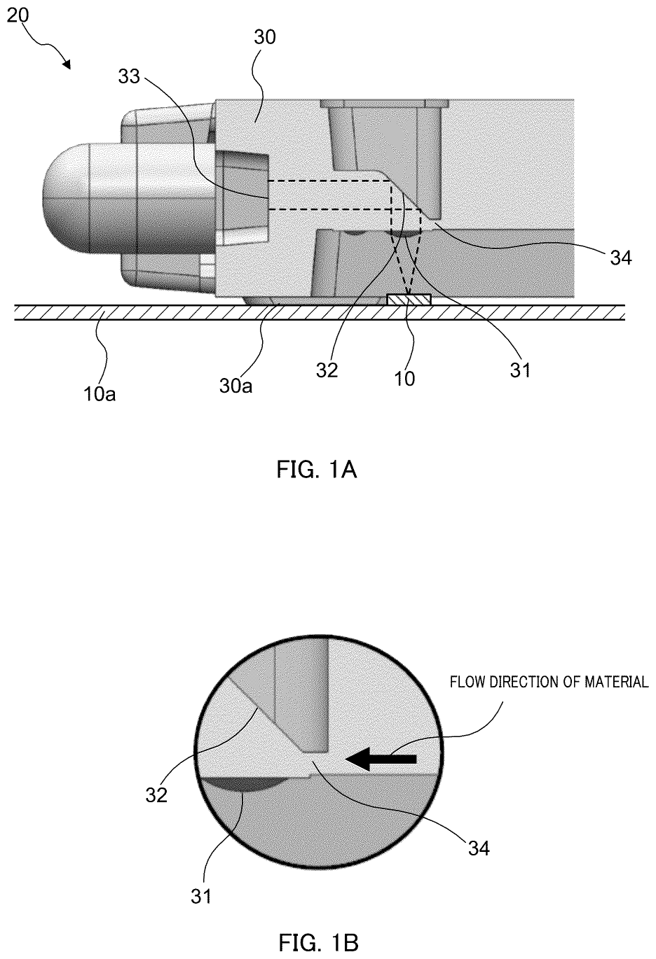

FIGS. 2A and 2B illustrate the configuration of an optical module according to an embodiment;

FIGS. 3A and 3B illustrate the configuration of an optical receptacle according to the embodiment;

FIGS. 4A to 4C illustrate the configuration of the optical receptacle according to the embodiment;

FIGS. 5A to 5C illustrate the configuration of the optical receptacle according to the embodiment; and

FIG. 6 illustrates a simulation result illustrating a position at which a weld line is generated in the optical receptacle.

### DESCRIPTION OF EMBODIMENTS

### Configuration of Optical Module Hereinafter, an optical module according to an embodiment of the present invention will be described in detail with reference to the accompanying drawings.

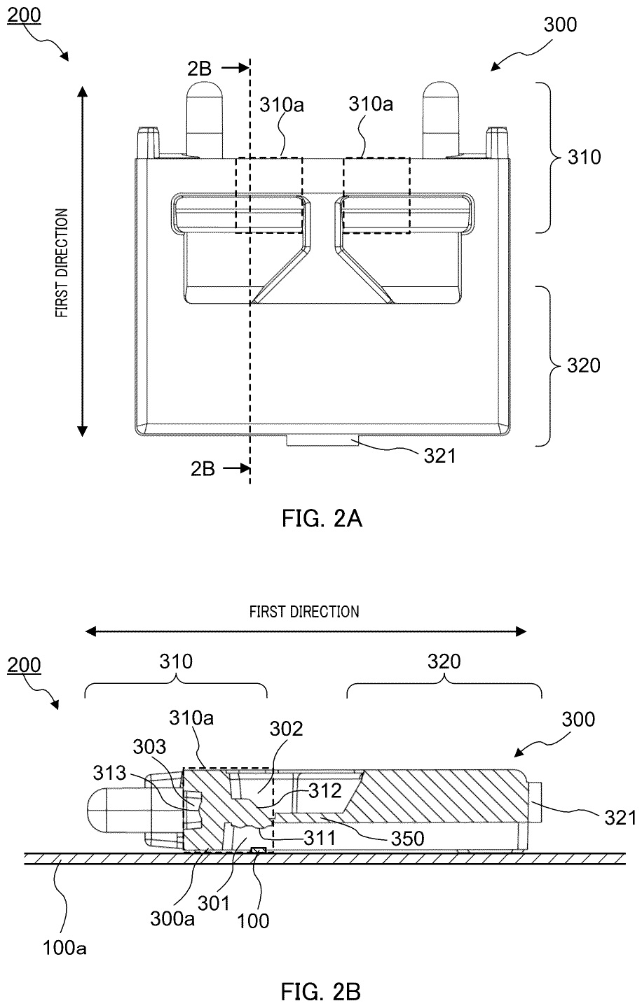

FIGS. 2A and 2B illustrate the configuration of optical module 200 according to the embodiment of the present invention. FIG. 2A is a plan view of optical module 200, and FIG. 2B is a cross-sectional view taken along line 2B-2B in FIG. 2A.

As illustrated in FIGS. 2A and 2B, optical receptacle 300 includes first part 310 disposed on one side in a first direction and second part 320 disposed on the other side in the first direction. First part 310 is a part having an optical function by including optical functional portion 310a (a portion surrounded by a broken line) for optically connecting photoelectric conversion element 100 disposed on substrate 100a with an end surface of an optical transmission member as illustrated in FIG. 2B. On the other hand, second part 320 is a part including a gate mark or gate remnant 321 remaining in optical receptacle 300 in accordance with injection molding of optical receptacle 300.

Optical module 200 may be used as optical module 200 for light transmission or optical module 200 for light reception.

When optical module 200 is used as optical module 200 for light transmission, light emitted from photoelectric conversion element 100 is controlled by optical functional portion 310a of first part 310 to reach an optical transmission member. Specifically, the light emitted from photoelectric conversion element 100 enters optical receptacle 300 through first optical surface 311 of optical functional portion 310a, is reflected by reflecting surface 312, and is emitted from optical receptacle 300 through second optical surface 313 to reach the end surface of the optical transmission member (not illustrated) (see FIG. 2B).

On the other hand, when optical module 200 is used as optical module 200 for light reception, light emitted from the end surface of an optical transmission member enters optical receptacle 300 through second optical surface 313 of optical receptacle 300, is reflected by reflecting surface 312, and is emitted from optical receptacle 300 through first optical surface 311 to reach photoelectric conversion element 100 (see FIG. 2B).

In optical receptacle 300, first optical surface 311 is disposed to face photoelectric conversion element 100 on substrate 100a. Optical receptacle 300 includes thin-wall portion 350 that is thinned due to the presence of first optical surface 311 formed in recess portion 301 recessed from the bottom surface side as illustrated in FIG. 2B and reflecting surface 312 formed in recess portion 302 recessed from the top surface side opposite to the bottom surface side. However, during injection molding, optical receptacle 300 according to the present embodiment has a configuration in which the occurrence of the molding defects can be suppressed even when thin-wall portion 350 is included. The configuration of the optical receptacle will be described in detail below.

Substrate 100a supports photoelectric conversion element 100 and optical receptacle 300. Substrate 100a is, for example, a glass composite substrate, a glass epoxy substrate, or a flexible substrate.

Photoelectric conversion element 100 is a light emitting element or a light receiving element. Photoelectric conversion element 100 is, for example, a vertical cavity surface emitting laser (VCSEL). The number of photoelectric conversion elements 100 is not particularly limited, is selected according to the configuration of optical receptacle 300 and may be one or more. In the present embodiment, the number of photoelectric conversion elements 100 is more than one (eight).

The type of optical transmission member is not particularly limited. Examples of the type of optical transmission member include an optical fiber and an optical waveguide. The number of optical transmission bodies is not particularly limited, is selected according to second optical surface 313 of optical receptacle 300 and may be one or more. In the present embodiment, the number of optical transmission bodies is more than one (eight).

### Configuration of Optical Receptacle

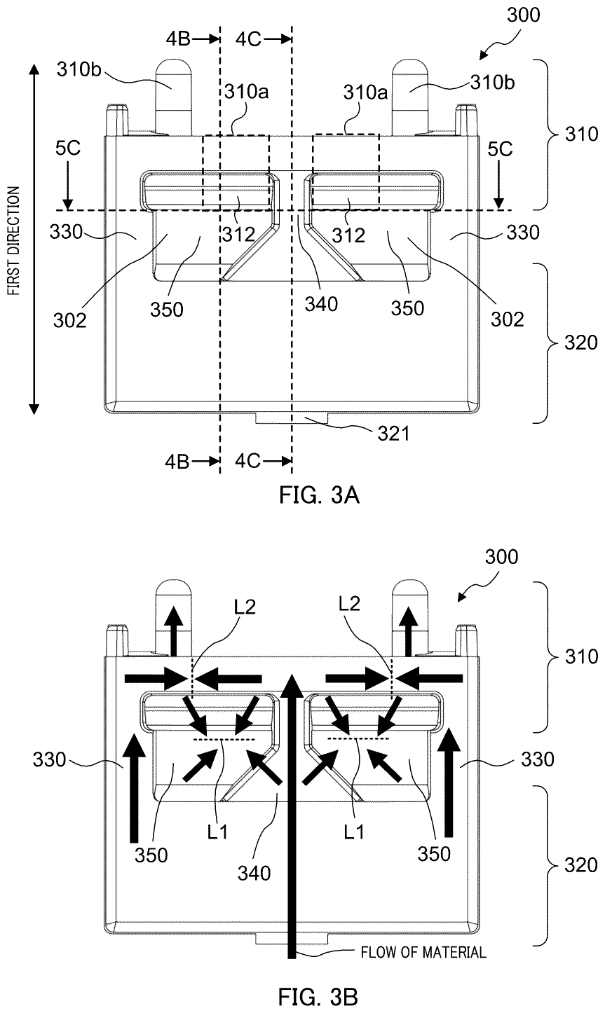

FIG. 3A is a plan view of optical receptacle 300. FIG. 3B illustrates the flow of a material in a plan view when optical receptacle 300 is injection molded.

As illustrated in FIG. 3A, optical receptacle 300 includes first part 310, second part 320, a pair of side connection portions 330, rib 340, and thin-wall portions 350. As described above, first part 310 is a part including optical functional portions 310a. Second part 320 is a part including gate mark or gate remnant 321. The pair of side connection portions 330, rib 340, and thin-wall portion 350 are disposed between first part 310 and second part 320.

Since optical receptacle 300 has such a configuration, as illustrated in FIG. 3B, first part 310 is obtained by molding of a material that flows in a cavity of a molding die from a portion corresponding to second part 320 through portions corresponding to the pair of side connection portions 330 and rib 340 to a portion corresponding to first part 310. In addition, thin-wall portion 350 is obtained by molding of a material that flows in the cavity of the molding die not only from the portion corresponding to second part 320 but also from the portion corresponding to first part 310, the portions corresponding to side connection portions 330, and the portion corresponding to rib 340. As a result, the molding defect of thin-wall portion 350 is suppressed.

First part 310, second part 320, the pair of side connection portions 330, rib 340, and thin-wall portion 350 are integrally molded, and thin-wall portion 350 has a thickness smaller than those of side connection portion 330 and rib 340. In addition, in the present embodiment, the thickness of optical receptacle 300 is approximately 1.3 mm.

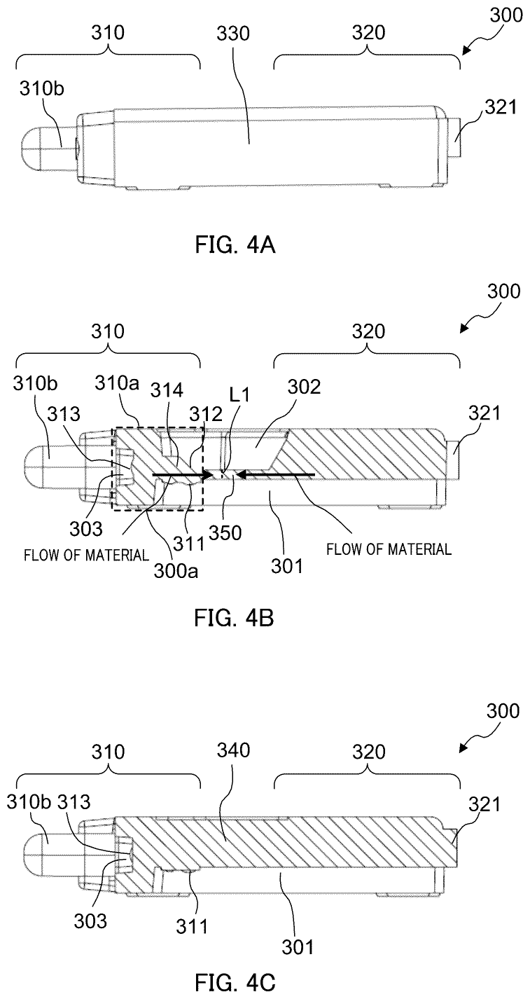

FIG. 4A is a side view of optical receptacle 300, FIG. 4B is a cross-sectional view taken along line 4B-4B of FIG. 3A, and FIG. 4C is a cross-sectional view taken along line 4C-4C of FIG. 3A. In FIG. 4B, the flow of the material in the vicinity of thin-wall portion 350 is also illustrated.

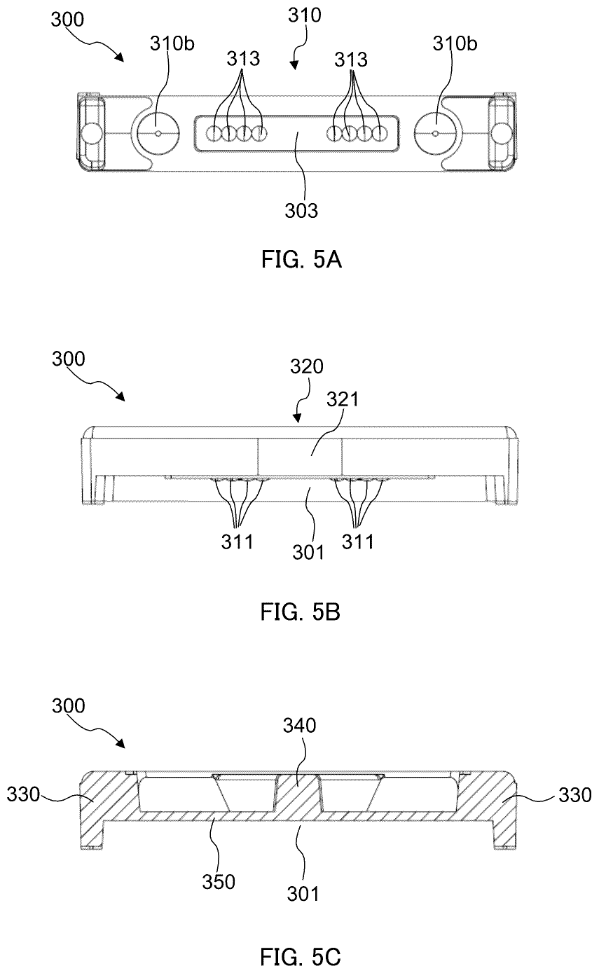

FIG. 5A is a front view of optical receptacle 300, FIG. 5B is a rear view of optical receptacle 300, and FIG. 5C is a cross-sectional view taken along line 5C-5C of FIG. 3A.

Hereinafter, details of each configuration of the optical receptacle will be described.

### First Part

First part 310 is a part that is disposed on one side (the front side of optical receptacle 300) in the first direction as illustrated in FIG. 3A and includes optical functional portion 310a. In addition, in the present embodiment, as illustrated in FIGS. 3A and 4B, the shape of first part 310 includes a substantially rectangular parallelepiped portion extending in a direction orthogonal to the first direction, and the substantially rectangular parallelepiped portion includes substantially cylindrical guide pins 310b extending to one side in the first direction and protruding portion 314 extending to the other side in the first direction.

As illustrated in FIG. 3B, first part 310 is mainly obtained by molding of a material that has passed through portions corresponding to side connection portions 330 and rib 340 in the cavity of the molding die.

More specifically, in the present embodiment, a part of the material flows through a portion corresponding to rib 340 disposed at the center of optical receptacle 300 from second part 320 toward first part 310 in a plan view, reaches the portion corresponding to first part 310, and is then divided into left and right parts, thereby filling the portion corresponding to first part 310.

On the other hand, another part of the material flows through portions corresponding to side connection portions 330 disposed on the left and right of optical receptacle 300 from second part 320 toward first part 310 in a plan view, reaches the portion corresponding to first part 310, is then bent toward the center, thereby filling the portion corresponding to first part 310.

At this time, the material that has passed through rib 340 and the materials that has passed through side connection portions 330 are joined at the front of optical receptacle 300 to form second weld lines L2. When second weld line L2 overlaps optical functional portion 310a, the function of optical functional portion 310a is impaired. Therefore, it is preferable that optical receptacle 300 is designed such that second weld line L2 does not overlap optical functional portion 310a.

Hereinafter, details of optical functional portion 310a included in first part 310 will be described. As illustrated in FIG. 4B, optical functional portion 310a includes first optical surface 311, reflecting surface 312, and second optical surface 313. Optical functional portion 310a is a portion in which an optical path is formed and which has an optical function.

### First Optical Surface

First optical surface 311 allows light emitted from photoelectric conversion element 100 to be incident on the surface, or first optical surface 311 emits, toward photoelectric conversion element 100, light emitted from the end surface of the optical transmission member and passing through the inside of optical receptacle 300.

First optical surface 311 is not particularly limited as long as the above-described function can be exhibited. The first optical surface may be a flat surface or a curved surface. In the present embodiment, the first optical surface is a curved surface, and more specifically, is a convex lens that is convex toward photoelectric conversion element 100.

First optical surface 311 is disposed on the bottom surface side of optical receptacle 300. More specifically, in the present embodiment, as illustrated in FIGS. 2B and 4B, first optical surface 311 is disposed on the inner surface of recess portion 301 formed on the bottom surface side in contact with substrate 100a of optical receptacle 300. From another viewpoint, as illustrated in FIG. 4B, first optical surface 311 is disposed on a side opposite to reflecting surface 312 in protruding portion 314 that protrudes from second optical surface 313 side toward thin-wall portion 350.

The number of first optical surfaces 311 is not particularly limited and may be one or more according to the number of photoelectric conversion elements 100. In the present embodiment, the number of first optical surfaces 311 is more than one (eight).

### Second Optical Surface

Second optical surface 313 emits, toward the end surface of an optical transmission member, light incident on first optical surface 311 and reflected by reflecting surface 312, or second optical surface 313 allows light emitted from the end surface of an optical transmission member to be incident on the surface.

Second optical surface 313 is not particularly limited as long as the above-described function can be exhibited. Second optical surface 313 may be a flat surface or a curved surface. In the present embodiment, second optical surface 313 is a curved surface, and more specifically, is a convex lens that is convex toward the optical transmission member.

Second optical surface 313 is disposed on the front side of optical receptacle 300. More specifically, in the present embodiment, as illustrated in FIG. 4B, second optical surface 313 is disposed on the inner surface of recess portion 303 disposed on the front of optical receptacle 300. When optical receptacle 300 is thinned, second optical surface 313 approaches bottom surface 300a, and the distance between second optical surface 313 and bottom surface 300a is reduced.

When optical receptacle 300 is thinned, the height of the second optical surface from bottom surface 300a is preferably as follows. That is, in a direction (up-down direction in FIG. 4B) along the optical path between first optical surface 311 and reflecting surface 312, the distance from an intersection between the optical axis of second optical surface 313 and second optical surface 313 to the bottom surface of optical receptacle 300 is preferably 1.1 mm or less.

The number of second optical surfaces 313 is not particularly limited and may be one or more according to the number of optical transmission bodies. In the present embodiment, the number of second optical surfaces 313 is more than one (eight).

### Reflecting Surface

Reflecting surface 312 is disposed on the optical path between first optical surface 311 and second optical surface 313 and reflects the light from first optical surface 311 toward second optical surface 313 or reflects the light from second optical surface 313 toward first optical surface 311.

Reflecting surface 312 is not particularly limited as long as the above-described function can be exhibited. In the present embodiment, reflecting surface 312 is a flat surface and is inclined at an angle of 45° with respect to bottom surface 300a. In addition, in the present embodiment, reflecting surface 312 is formed in recess portion 302 recessed from the top surface side of optical receptacle 300. Recess portion 302 is located between first part 310 and second part 320 and is located between side connection portion 330 and rib 340. In addition, in the present embodiment, as illustrated in FIG. 4B, reflecting surface 312 is also a part of the surface of protruding portion 314 protruding from second optical surface 313 side toward thin-wall portion 350. In the present embodiment, reflecting surface 312 is disposed on a side opposite to first optical surface 311 in protruding portion 314.

### Guide Pin

As illustrated in FIG. 3A and the like, in the present embodiment, first part 310 includes guide pin 310b. Guide pin 310b is a protruding portion that is fitted into a recess portion provided in a ferrule that holds end parts of a plurality of optical transmission bodies (optical fibers), and the end surface of the optical transmission member is positioned with respect to optical receptacle 300 (second optical surface 313) by the fitting.

As illustrated in FIGS. 3A and 3B, it is preferable that guide pin 310b does not overlap second weld line L2. When guide pin 310b and second weld line L2 overlap each other, the molding of guide pin 310b becomes insufficient, and the positioning accuracy when guide pin 310b is fitted into the recess portion provided in the ferrule may become insufficient. In addition, the strength of guide pin 310b may become insufficient to fit into the recess portion. Therefore, it is preferable that guide pin 310b and second weld line L2 do not overlap each other.

In the present embodiment, the number of guide pins 310b is two, and guide pins 310b are respectively disposed on the left and right so as to protrude from the front of optical receptacle 300.

### Thin-Wall Portion

As illustrated in FIG. 3A, thin-wall portion 350 is disposed in the following space: the space is surrounded by first part 310, second part 320, and the pair of side connection portions 330, and rib 340 is not located in the space. In the present embodiment, thin-wall portion 350 is located at the bottom of recess portion 302 surrounded by first part 310, second part 320, side connection portions 330, and rib 340. Thin-wall portion 350 has a thickness smaller than those of the pair of side connection portions 330 and rib 340. The thickness of thin-wall portion 350 is not particularly limited, but is preferably 0.09 mm or more and preferably 0.27 mm or less. By setting the thickness of thin-wall portion 350 to 0.09 mm or more, it is possible to appropriately fill thin-wall portion 350 with a resin to be molded. By setting the thickness of thin-wall portion 350 to 0.27 mm or less, it is possible to prevent first weld line L1 formed on thin-wall portion 350 from being located near the optical path.

As described above with reference to FIGS. 3A and 3B, thin-wall portion 350 is formed of materials that flow in the cavity of the molding die, namely a material passing through the portions corresponding to rib 340 and side connection portion 330 to flow from the portion corresponding to second part 320 and a material flowing from the portion corresponding to first part 310. As a result, as illustrated in FIGS. 3B and 4B, first weld line L1 is formed on thin-wall portion 350. Thin-wall portion 350 including first weld line L1 means that first weld line L1 is not formed on optical functional portion 310a illustrated in FIG. 3A. As a result, the optical function is not impaired. In optical receptacle 300 according to the present embodiment, the cross-sectional area of side connection portion 330, the cross-sectional area of rib 340, and the thickness (cross-sectional area) of thin-wall portion 350 are adjusted such that first weld line L1 is separated from optical functional portion 310a.

### Side Connection Portion

Side connection portions 330 are a pair of members that connect first part 310 with second part 320 and are disposed on both sides of optical receptacle 300. In the present embodiment, side connection portion 330 has a substantially rectangular parallelepiped shape extending in the first direction.

As illustrated in FIG. 3B, in the cavity of the molding die, the portion corresponding to side connection portion 330 is one of main paths through which the material flows from the portion corresponding to second part 320 toward the portion corresponding to first part 310, together with the portion corresponding to rib 340. It is preferable that side connection portion 330 is appropriately designed to create the flow of the material as illustrated in FIG. 3B. That is, together with the cross-sectional area of rib 340 and the cross-sectional area of thin-wall portion 350, the cross-sectional areas of the pair of side connection portions 330 are designed such that first weld line L1 is formed on thin-wall portion 350. In addition, it is preferable that, together with the cross-sectional area of rib 340, the cross-sectional areas of the pair of side connection portions 330 are designed such that second weld line L2 does not overlap optical functional portion 310a. By virtue of these configurations, first weld line L1 and second weld line L2 are not formed on optical functional portion 310a, so that the optical function is not impaired.

The cross-sectional area of each of the above-described portions varies in various ways depending on molding conditions (for example, conditions for injection molding), but can be set, for example, as follows.

That is, for example, among the cross-sectional areas of rib 340, the pair of side connection portions 330, and thin-wall portion 350, the smallest cross-sectional area may be the cross-sectional area of rib 340, the largest cross-sectional area may be the cross-sectional areas of the pair of side connection portions 330, and the intermediate cross-sectional area may be the cross-sectional area of thin-wall portion 350. In addition, for example, the cross-sectional area of rib 340 may be 0.5 to 0.7 mm², the cross-sectional areas of the pair of side connection portions 330 may be 1.3 to 1.5 mm², and the cross-sectional area of thin-wall portion 350 may be 0.6 to 0.8 mm². In addition, for example, the cross-sectional area of rib 340 may be 0.6 mm², the cross-sectional areas of the pair of side connection portions 330 may be 1.4 mm², and the cross-sectional area of thin-wall portion 350 may be 0.7 mm^{2.}

The cross-sectional area is an area in a cross section orthogonal to the first direction. More specifically, the cross-sectional areas of the pair of side connection portions 330 are areas in a cross section in which the total cross-sectional area of the pair of side connection portions 330 is the smallest among the cross sections orthogonal to the direction orthogonal to the first direction. In a similar manner, the cross-sectional area of rib 340 is an area in a cross section in which the cross-sectional area of rib 340 is the smallest among the cross sections orthogonal to the direction orthogonal to the first direction. The cross-sectional area of thin-wall portion 350 is an area in a cross section in which the total cross-sectional area of thin-wall portions 350 is the largest among the cross sections orthogonal to the direction orthogonal to the first direction.

### Rib

Rib 340 is disposed between the pair of side connection portions 330 and connects first part 310 with second part 320. In the present embodiment, as illustrated in FIG. 3A, rib 340 extends at the center of optical receptacle 300 in the first direction in a plan view of optical receptacle 300. As described above, in the cavity of the molding die, the portion corresponding to rib 340 is one of the main paths through which the material flows together with the portions corresponding to the pair of side connection portions 330. Therefore, as described above, the cross-sectional area of rib 340 is designed, together with the cross-sectional areas of the pair of side connection portions 330 and the cross-sectional area of thin-wall portion 350, in such a way that first weld line L1 is formed on thin-wall portion 350. In addition, it is preferable that the cross-sectional area of rib 340 is designed, together with the cross-sectional areas of the pair of side connection portions 330, in such a way that second weld line L2 does not overlap optical functional portion 310a.

From the viewpoint of improving the flow of the material, it is preferable that, in a plan view of optical receptacle 300, the width of rib 340 on a side close to second part 320 is larger than the width of rib 340 on a side close to first part 310. More specifically, in the present embodiment, in a plan view of optical receptacle 300, rib 340 includes a portion whose width gradually decreases from second part 320 side toward first part 310 side and a portion whose width is constant from second part 320 side toward first part 310 side in first part 310, as illustrated in FIG. 3A. That is, rib 340 has a funnel-like shape in a plan view.

### Second Part

As illustrated in FIG. 3A, second part 320 is a part that is disposed on the other side in the first direction with respect to first part 310 disposed on one side in the first direction. Second part 320 is a part disposed on the rear side of optical receptacle 300. In the present embodiment, second part 320 has a substantially rectangular parallelepiped shape extending in a direction orthogonal to the first direction. In addition, in the present embodiment, second part 320 includes gate remnant 321 that is a part of a gate remaining in optical receptacle 300 after the gate is cut—the gate having served as a passage for a material during injection molding. Second part 320 may include a gate mark that is a gate trace remaining in optical receptacle 300 after the part of the gate is removed so that it does not remain on optical receptacle 300. As illustrated in FIG. 3A, in a plan view of the optical receptacle, gate remnant 321 (or the gate mark) is disposed on an extension line of rib 340 extending in the first direction. In this manner, the material can be supplied to first part 310 more efficiently.

The invention described in the present embodiment is particularly useful when the thickness of a filling region of a resin is 0.27 mm or less as in thin-wall portion 350 described in the present embodiment, and the resin filling the molding die (for example, a metal mold) is more likely to be solidified and the weld line is more likely to be generated.

### Simulation

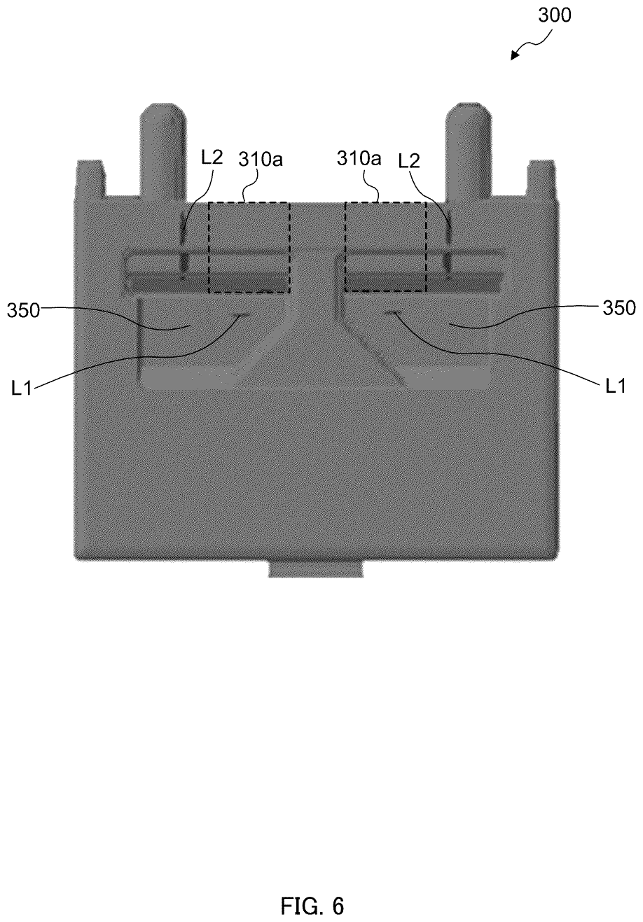

FIG. 6 illustrates the results of a flow analysis simulation when optical receptacle 300 having the above-described configuration is injection molded. As illustrated in FIG. 6, when optical receptacle 300 having the above-described configuration is injection molded, the weld line L2 is formed on thin-wall portion 350 and is not formed on optical functional portion 310a, and as a result, the optical function is not impaired. In addition, the weld line L1 is not formed on optical functional portion 310a, and as a result, the optical function is not impaired. In addition, thin-wall portion 350 could be molded without any problem.

### Effect

Optical receptacle 300 according to the embodiment of the present invention includes the pair of side connection portions 330 that connect first part 310 with second part 320, and rib 340 between the pair of side connection portions 330. The cross-sectional areas of side connection portions 330, rib 340, and thin-wall portions 350 are adjusted. As a result, the occurrence of the molding defects of optical receptacle 300 according to the present embodiment is suppressed. In addition, the weld lines L1 and L2 are not formed on optical functional portion 310a.

### Industrial Applicability

The optical receptacles and optical modules according to the present invention are particularly advantageous for optical communication using, for example, an optical transmission member.

### Reference Signs List

10, 100 Photoelectric conversion element
10a, 100a Substrate
20, 200 Optical module
30, 300 Optical receptacle
30a, 300a Bottom surface
32, 312 Reflecting surface
33, 313 Second optical surface
34, 350 Thin-wall portion
301, 302, 303 Recess portion
310 First part
310a Optical functional portion
310b Guide pin
311 First optical surface
314 Protruding portion
320 Second part
321 Gate remnant
330 Side connection portion
340 Rib
L1 First weld line
L2 Second weld line

1. An optical receptacle for optically connecting a photoelectric conversion element with an end surface of an optical transmission member when the optical receptacle is disposed between the photoelectric conversion element and the optical transmission member, the optical receptacle comprising:
a first part that is disposed on one side in a first direction and has an optical function for optically connecting the photoelectric conversion element with the end surface of the optical transmission member;
a second part that is disposed on another side in the first direction and includes a gate mark or a gate remnant;
a pair of side connection portions that connect the first part with the second part;
a rib that is disposed between the pair of side connection portions and connects the first part with the second part; and
a thin-wall portion that is disposed in a space surrounded by the first part, the second part, and the pair of side connection portions and has a thickness smaller than those of the pair of side connection portions and the rib, the space being a space in which the rib is not located,
wherein
the first part, the second part, the pair of side connection portions, the rib, and the thin-wall portion are integrally molded, and
respective cross-sectional areas of the pair of side connection portions, the rib, and the thin-wall portion in a cross section in a direction orthogonal to the first direction are designed in such a way that a first weld line is formed on the thin-wall portion.

2. The optical receptacle according to claim 1, wherein
the thickness of thin-wall portion is 0.09 mm or more.

3. The optical receptacle according to claim 1, wherein
the first part includes a second weld line at a position at which the second weld line does not overlap an optical path of the optical function.

4. The optical receptacle according to claim 1, wherein
the gate mark or the gate remnant is disposed on an extension line of the rib.

5. The optical receptacle according to claim 1, wherein
the first part includes
a first optical surface for allowing light emitted from the photoelectric conversion element to be incident on the first optical surface or for emitting, toward the photoelectric conversion element, light emitted from the end surface of the optical transmission member and passing through an inside of the first part,
a second optical surface for emitting, toward the end surface of the optical transmission member, the light incident on the first optical surface or for allowing the light emitted from the end surface of the optical transmission member to be incident on the second optical surface, and
a reflecting surface for reflecting the light from the first optical surface toward the second optical surface or for reflecting the light from the second optical surface toward the first optical surface.

6. The optical receptacle according to claim 5, wherein
in a direction along an optical path between the first optical surface and the reflecting surface, a distance from an intersection between an optical axis of the second optical surface and the second optical surface to a bottom surface of the optical receptacle is 1.1 mm or less.

7. An optical module comprising:
a photoelectric conversion element; and
the optical receptacle according to claim 1.
